(19) United States
(12) Patent Application Publication
(10) Pub. No.: US 2010/0278977 A1
(43) Pub. Date: Nov. 4, 2010

(54) Health characteristic Caramel Flavored Confection, Chews, Hard Candy, and Caramel Flavored Milk

(76) Inventor: Gary Ervin, Naples, FL (US)

Correspondence Address: Gary Ervin, 3431 8th Ave S.E., Naples, FL, 34117, US

(21) Appl. No.: 12/764,957

(22) Filed: Apr. 22, 2010

Related U.S. Application Data
(60) Provisional application No. 61/171,804, filed on Apr. 22, 2009.

(51) Int. Cl. A23G 3/36; A23G 3/40; A23G 3/42; A23G 3/46; A23L 1/302; A23L 1/304; A23G 3/48; B65D 85/72; A23L 1/01; A23L 1/27

(52) U.S. Cl. 426/72; 426/541; 426/74; 426/115; 426/131; 426/250

(57) ABSTRACT

The present invention provides for caramel flavored confections, chews, hard candies or caramel flavored milk that has an improved, healthier fat structure, unique antioxidant taste profile, fiber component, and a 0% or greater supplement component that can add additional dietary benefits. Cholesterol reduction and cardiovascular health and removal of cholesterol from the bloodstream can be accomplished within certain compositions of this invention. Specific ratios of ingredients create a taste, texture, to mouthfeel, and rich flavor similar to a high milk fat or butter fat based caramel without the negative health ramifications of high milk fat based type caramels. Additionally, the method for preparing a caramel flavored confection, chews, and milk with these improved health characteristics, taste profile, and dietary benefits are covered.

### FIELD OF THE INVENTION

The present application claims the benefit of U.S. Provisional Application Ser. No. 61/171,804 filed Apr. 22, 2009.

### BACKGROUND OF THE INVENTION

The present invention relates generally to ingestible caramel flavored confectionery compositions that have improved health characteristics, antioxidant content, less sugar, balance of dietary fats and particularly compositions which facilitate use as ice cream toppings, as fillings for confectionery products, as a layer for a confectionery product or food, or as bite size pieces or chews or bite size hard candies pieces or shapes. The caramel flavored confection can also be used as a base for making caramel flavored milk. Supplements can be added to the caramel flavored confections to target certain health issues such as cholesterol control or triglycerides control that supports prevention of cardiovascular disease.

Caramel flavored confections currently available in the marketplace are produced in one of three ways. First, many caramel flavored confections used for ice cream toppings are made fat free utilizing skim milk or sweetened condensed skim milk and several forms of sugar. These fat free caramel flavored confections exhibit high sugar levels in the range of 50% plus sugar, have little nutritional value, and have texture and viscosity more similar to syrup than to high quality caramel. These fat free caramel flavored confections are usually inexpensive to manufacture because milk fat or butter components, which are the most expensive components found in traditional caramel and these specific ingredients are not included in such “fat free” compositions.

Second, many caramel flavored confections currently available in the market place are made with whole milk or condensed whole milk, whole milk powder, or other sources of milk solids such as butter or heavy cream. These caramel flavored confections meet the common definition of caramel and have milk fat or butter fat or both only as components of the composition's fat content. These caramel flavored confections or caramel have rich and creamy taste, texture, and exhibit superior melt characteristics compared to fat free caramel flavored confections. These milk fat and or butter fat based caramel flavored confections or caramel like the “fat free” caramels described in the previous paragraph, exhibit high sugar content. This high sugar content combined with high levels of animal saturated fat within these compositions has negative health implications vis a vis established medical science regarding cardiovascular disease and heart disease as well as can contribute to diabetes.

Third are the types of caramel flavored confections that use fats such as palm kernel oil, palm oil or partially hydrogenated and fully hydrogenated oils alone or in combinations with milk fat. The caramel flavored confections that utilize palm kernel oil or palm oil only are superior from a health perspective vs. those that use partially and fully hydrogenated oils because these caramel flavored confections have Trans fat as part of their structure. A large percentage of the caramel flavored confections used in the confectionery industry are made with partially or fully hydrogenated oils because these oils are inexpensive and contribute to the creation of a less viscous and more stable composition. The Trans fats that are contained in these partially and fully hydrogenated oils have proven negative health characteristics and are widely recognized within the medical literature as contributors to cardiovascular and heart disease.

Our invention can create caramel flavored confection compositions that exhibit the taste, texture, melt, and creaminess of a high milk fat or butter fat caramel without incorporating animal saturated fats which are found within milk fat or butter fat. Our invention can produce a caramel flavored confection or caramel flavored confection chew, hard candy or confectionery filling, or confection or caramel flavored milk that has improved health characteristics, antioxidant content, reduced sugar content and dietary benefits compared to fat free caramel flavored confection or milk fat and/or butter fat caramel flavored confection or caramel products that use high saturated fat oils like palm oil. Our invention can create caramel flavored confection compositions that have no Trans fat within the compositions and that in certain embodiments can help with cholesterol control. Within certain embodiments of our invention we can provide a healthier group of dietary fats including Omega 6 and Omega 3 ALA's and dietary fiber that has probiotic benefits.

### 1. Description of Related Art by Product Type

The art of preparing true caramel candy includes cooking sugar, milk, and fat to prepare any of the various kinds of caramel, including wrapped caramels, plastic cast caramels, cast grained caramels, semi-short chocolate caramels, caramel coating for nougat rolls, summer-type chocolate caramels, and the like as described, for example, by J. J. Alikonis, CANDY TECHNOLOGY, AVI Publishing Co., 1983, pages 147, et sec. Caramel candies of these types have not permitted the preparation of all of the various types of caramel-flavored confections as would be desired.

U.S. Pat. No. 5,384,148 to Lynch, et al., describes the preparation of caramel confections which are said to facilitate coating, depositing, molding and baking. These are prepared from a finely divided solid candy phase dispersed within a continuous fat phase. These products again differ from conventional caramel products which are based on sugars and milk protein and typically exhibit a chewy texture. The products of Lynch, et al., are essentially dry with powdered caramel mixed with fat and an emulsifier.

The Lynch, et. al., process calls for preparing a powdered caramel brittle material by sheeting, cooling and grinding a caramel prepared by cooking aqueous milk solids with sugar to a moisture level of below 6%. Then, from 5 to 35% of the powdered caramel brittle is mixed with 30 to 60% granulated sugar, 17 to 40% fat, and 10 to 25% milk solids. The mixture is refined to obtain an average particle size of 0.0004 to 0.0020 inches, mixed with an emulsifying agent and additional vegetable fat, and heated to reduce the moisture level to a level (about 0.8% in the Example) suitable for using the confection as a coating. The flavor is said to be caramel like, but the texture is clearly different from caramel. Our invention differs from the Lynch, et al. process because we actually produce a caramel flavored confection similar to regular caramel in all important respects including flavor, melt and texture. We can either produce our product all at once in a regular caramel processing method or we can utilize a finished caramel flavored confection as the base and blend our additional components into the base to produce the finished product. We can make caramel chews by reducing the water content in our finished caramel flavored confection. Lynch, et. al. mentions no consideration of health implications in its compositions, where as our compositions utilize types of edible oils proven to offer health benefits and include the addition of a fiber component to provide additional health benefits.

Other oil-based coatings are described by Hoffman in U.S. Pat. No. 2,524,291. These coatings can be employed as toppings or casings for ice cream, confectionery and other foods. The process employs water-soluble colors in combination with a water-in-oil emulsifying agent, such as lecithin, to provide coatings with a wide variety of colors, each being uniform in appearance. Among the colors mentioned is a brownish tint, formed by a combination of red, yellow and blue U.S. certified colors, useful for coloring a butterscotch or caramel flavored coating. The flavor compositions for these coatings are not identified. Separation of fat from caramel is not mentioned because real caramel is not employed. The flavor might be adjusted to taste like caramel, but is not true caramel, and the texture, is of a fatty coating, not of true caramel.

Patent Application 20060286212, Yu; Weizhu, June 2005 suggests a low moisture, low water activity caramel, caramel composite product. The goal of Yu; Weizhu was to create a caramel confection that could be in direct contact with a crisp component.

Weizhu utilizes an edible oil component with a high level of unsaturated fats which results in their caramel confection offering some health benefits. However, the Weizhu formulations also include milk solids from whole milk sources. This contributes milk fat to their compositions and this saturated animal fat component diminishes the cardiovascular and hearth health aspects of their formulation. Our invention utilizes healthier edible oils and uses a skim milk component for the milk solids. We have a coconut oil component and vanilla powder antioxidant flavor profile in our compositions that replaces milk fat with a healthier group of plant based saturated fats rather than animal saturated fats found in milk fat. We also have a dietary fiber component within our invention that adds further health benefits and can displace sugar carbohydrates within our compositions. All of these factors contribute to a more heart healthy formulation vs Weizhu.

Patent Application 20090061069, Warnecke; Melvin O.; et al., September 2007 suggests a caramel flavored confection with high protein content, and methods of making the confection. While nutritional value is obviously important in the Warnecke; Melvin O.; et al. invention our nutrition platforms differ widely. Warnecke; Melvin O.; et al. creates a caramel flavored confection with protein being the critical health characteristic of their invention. They purport a finished product with 12% to 50% protein as the primary health benefit of their caramel flavored confection. Whereas our invention creates a caramel flavored confection that has an improved balance of dietary fats including beneficial essential fatty acids Omega 6 and Omega 3, dietary fiber that can have probiotic benefits, and antioxidant benefits. Our invention is not intended to provide protein related health benefits.

### Low Fat vs Balanced Fats

Much work has been done to create low fat or reduced fat standardized chocolate or non-standardized chocolate compositions. U.S. Pat. No. 5,464,649 to St. John, et. al. discloses a lowfat chocolate confection that can be made with as low as 25% total fat having flow properties suitable for molding, extruding or enrobing operations. It was initially thought that low fat was the most important aspect of our diet that contributes to improved health for the consumer.

In the 1980's the FDA established food claims guidelines including ones that were based on a “low fat” diet being important to reduce the risk of coronary heart disease and to improve consumer's health. Through continued scientific study it has been found that it is not the amount of fat in the diet per se that is the critical aspect for reducing health related issues like; coronary heart disease, diabetes, obesity, and other health issues, but rather the types of fats and the balance of those fats which are included in foods. (see http://www.hsph.harvard.edu/nutritionsource/what-should-you-eatffats-full-story/index.html)

As food producers responded to the FDA guidelines of the 1980s many “low fat” foods including confectionery foods like Smucker's toppings and Hershey's caramel fat free caramel flavored ice cream toppings were introduced. The 2005 USDA Dietary Guidelines; however, now suggests under its fat recommendations that consumers should reduce the amount of saturated fat in the diet and replace it with unsaturated fatty acids like monounsaturated and polyunsaturated fats. Consensus in the medical community, based on clinical research and food studies, is that increased levels of monounsaturated and polyunsaturated fats in the diet would help in the prevention of cardiovascular disease and coronary heart disease related problems.

The link below discusses the Harvard School of Public Health study that was the largest food study ever created to examine how certain fats affect consumer's long term health. The conclusion is that consumers need to get more of the “good unsaturated fats” (unsaturated fats including monounsaturated and polyunsaturated fats) and less of the saturated fats in their diets. The current invention creates caramel flavored confections that have new structures to improve the taste, texture, melt, and creaminess while providing beneficial monounsaturated and polyunsaturated fat content. Certain embodiments of this invention can add the essential fatty acids Omega 6 and Omega 3 ALA's which are currently found in extremely small amounts in milk fat or butter fat based caramel confections and not at all in fat free caramel flavored confections.

http://www.hsph.harvard.edu/nutritionsource/what-should-you-eat/fats-full-story/index.html

This report is based on the largest study ever undertaken on the effect of reducing saturated fats and replacing them with unsaturated fats including monounsaturated and polyunsaturated fats. The study concluded that many of the major health issues facing to consumers today can be directly attributed to consumption of high levels of saturated fat, partially hydrogenated, fully hydrogenated, and Trans fats. The study examined the effect of replacing such saturated fats with healthier monounsaturated and polyunsaturated fats in the diet and how certain saturated fats like those found in coconut are significantly better for you than saturated fat found in milk and butter. The study concluded that this had a significant effect on reducing the risks of developing chronic health conditions including cardiovascular disease and coronary heart disease.

### SUMMARY OF THE INVENTION

It is, therefore, an object of this invention to provide an improved taste, improved texture, and improved melt, creamier caramel flavored confection without the necessity of utilizing milk fat or butter fat or partially or fully hydrogenated fats that have negative health consequences. This caramel flavored confection can be made in the typical caramel producing manner or can be made utilizing an already made caramel flavored confection as a base for the composition. It is another object of the present invention to create a caramel flavored confection that can have an improved balance of dietary fats including saturated fats, polyunsaturated fats, and monounsaturated fats including beneficial Omega 6 and Omega 3 fatty acids. It is another object of this invention to have an antioxidant flavor profile that gives the caramel flavored confection a specific unique novel flavor that comes from the synergy of coconut oil, vanilla powder, and the caramelization process flavors. The flavor profile thus created is a completely unique taste profile vs. all other caramel flavored confections currently in the market place.

It is another object of the present invention to create caramel flavored confections that have a beneficial dietary fiber component. This dietary fiber component gives our invention a specific improved texture and creaminess as well as positive health attributes. Inulin is the preferred fiber source for our caramel flavored confection. Inulin is indigestible by human enzymes ptyalin and amylase, which are designed to digest starch. As a result, inulin passes through much of the digestive system intact. Inulin is a highly effective prebiotic, stimulating the growth of beneficial probiotic bacteria in the gut. Inulin is used in low fat products because of its ability to give a creamy smooth to texture to products. Inulin is a dietary fiber and is believed to activate beneficial good bacteria in the digestive tract. The activation of these bacteria is thought to reduce the risk of bowel cancer. Inulin has a mildly sweet taste, but does not affect blood sugar levels and is recommended for diabetics. Inulin has been clinically proven to increase calcium absorption. The inherent calcium in dairy foods is now an even better source of this bone-building mineral when inulin is added because inulin improves the body's uptake. People have used plants containing inulin to help relieve diabetes mellitus, a condition characterized by hyperglycemia and/or hyperinsulinemia.

It is another object of our invention to create a caramel flavored confection that can help with cholesterol control and high triglycerides that both are health issues that lead to increased risk of cardiovascular disease. Cholesterol and specifically the plaque that it causes in the bloodstream and high triglycerides are leading contributing factors to cardiovascular disease and coronary heart disease. In certain embodiments of our invention we can add supplements to our caramel flavored confections that include plant sterols and Omega 3 DHA/EPA supplements. These two supplements have proven beneficial effects on cholesterol control and lowering the risk for developing cardiovascular disease in the human body and can actually remove bad cholesterol plaque from the bloodstream. The science behind how plant sterols and Omega 3 DHA/EPA supplements affect cholesterol and triglycerides in the human body is well established. Below is several links that produce scientific evidence confirming the relationship between cholesterol control and triglyceride control using plant sterols and Omega 3 DHA/EPA supplements within the daily healthy diet:

### Plant Sterol Medical Science Cholesterol Control:

http://mednews.wustl.edu/tips/page/normal/6744.html
http://www.webmd.com/cholesterol-management/features/low-cholesterol-diet-plant-sterols-stanols

### Omega 3 DHA/EPA Medical Science Cholesterol Control:

http://dhaomeqa3.org/index.php?category=health-conditions&title=Mar08-10
http://circ.ahajournals.org/cgi/content/full/106/21/2747#SEC2

It is another object of the present invention to provide a caramel flavored confection that can claim a nutritional structure that the medical community including the FDA would concede is heart healthy. Within certain embodiments of this invention we can create caramel flavored confection compositions with superior taste that have a balance of dietary fats while actually increasing the antioxidant content of the product without the necessity of adding milk fat, butter fat, partially hydrogenated or fully hydrogenated fats that normally would be in a caramel flavored confection formulation. Our caramel flavored confection compositions can contain the beneficial essential fatty acids Omega 6 linoleic and Omega 3 ALA's alpha-linolenic in the compositions based on the healthier edible oils used within these composition. Based on this completely new structure of a caramel flavored confection composition we believe that a heart healthy claim is within reach for our compositions. We can also add supplements to our caramel flavored confection that deliver therapeutic amounts of fiber, plant sterols, Omega 3 DHA/EPA and others that can target cholesterol control and support lowering the risk for cardiovascular disease. Below is a link to a site that shows the FDA approval for allowing Frito Lay to market snacks that have substantial amounts of saturated fats replaced with unsaturated fats. Science links the replacement of saturated fats with unsaturated fats as a way to reduce the risk of heart disease and other chronic health problems that face the US and global populations.

http://www.foodnavigator-usa.com/Financial-Industry/FDA-approves-unsaturated-fat-health-claim

The ability to remove milk fat, butter fat, partially hydrogenated or fully hydrogenated fat from caramel flavored confections offers the potential for a profound effect on consumer's health by removing millions of pounds of milk and butter saturated fat and Trans fat currently found in standard caramel flavored confections. The preferred embodiments of our caramel flavored confection invention use healthier saturated fat from coconut oil and increase good monounsaturated and polyunsaturated fat content and deliver antioxidants and dietary fiber to the consumer.

These and other objects and advantages of the present invention shall become apparent from the description.

In one embodiment of the invention a caramel flavored confection has improved taste, texture, melt, and creaminess versus fat free caramel flavored confections and has a balance of dietary fats plus beneficial essential fatty acids Omega 6 and Omega 3 ALA's, antioxidants, and dietary fiber versus milk fat or butter fat based or partially hydrogenate or fully hydrogenated fat caramel flavored confections or caramel.

Such a caramel flavored confection composition comprises:
a. liquid edible oil component at 12% to 20% (blend of canola, soybean oil and sunflower oil)
b. 3% to 5% coconut oil component (0% to 16% virgin coconut oil and 84% to 100% refined coconut oil)
c. condensed skim milk component at 20% to 30%
d. monosaccharide component at 15% to 20%
e. disaccharide component at 18% to 23%
f. vanilla powder component of 3%
g. an emulsifier component at 0.001% to 5%
h. fiber component at 0.001% to 20%
i. 1% or greater water component

An embodiment of the present invention is a composition comprising: a. liquid edible oil component at 12% to 20% (blend of canola, soybean oil and sunflower oil), by weight of said composition; b. 3% to 5% coconut oil component (0% to 16% virgin coconut oil to and 84% to 100% refined coconut oil), by weight of said composition; c. and condensed skim milk component at 20% to 30%, by weight of said composition.

A further embodiment of the present invention is a composition comprising: a. liquid edible oil component at 12% to 20% (blend of canola, soybean oil and sunflower oil), by weight of said composition; b. 3% to 5% coconut oil component (0% to 16% virgin coconut oil and 84% to 100% refined coconut oil), by weight of said composition; c. condensed skim milk component at 20% to 30%, by weight of said composition; d. monosaccharide component at 15% to 20%, by weight of said composition; e. and disaccharide component at 18% to 23%, by weight of said composition.

A further embodiment of the present invention is a composition comprising: a. liquid edible oil component at 12% to 20% (blend of canola, soybean oil and sunflower oil), by weight of said composition; b. 3% to 5% coconut oil component (0% to 16% virgin coconut oil and 84% to 100% refined coconut oil), by weight of said composition; c. condensed skim milk component at 20% to 30%, by weight of said composition; d. monosaccharide component at 15% to 20%, by weight of said composition; e. disaccharide component at 18% to 23%, by weight of said composition; f. and vanilla powder component of 3%, by weight of said composition.

A further embodiment of the present invention is a composition comprising: a. liquid edible oil component at 12% to 20% (blend of canola, soybean oil and sunflower oil), by weight of said composition; b. 3% to 5% coconut oil component (0% to 16% virgin coconut oil and 84% to 100% refined coconut oil), by weight of said composition; c. condensed skim milk component at 20% to 30%, by weight of said composition; d. monosaccharide component at 15% to 20%, by weight of said composition; e. disaccharide component at 18% to 23%, by weight of said composition; f. vanilla powder component of 3%, by weight of said composition; g. and an emulsifier component at 0.001% to 5%, by weight of said composition.

A further embodiment of the present invention is a composition comprising: a. liquid edible oil component at 12% to 20% (blend of canola, soybean oil and sunflower oil), by weight of said composition; b. 3% to 5% coconut oil component (0% to 16% virgin coconut oil and 84% to 100% refined coconut oil), by weight of said composition; c. condensed skim milk component at 20% to 30%, by weight of said composition; d. monosaccharide component at 15% to 20%, by weight of said composition; e. disaccharide component at 18% to 23%, by weight of said composition; f. vanilla powder component of 3%, by weight of said composition; g. an emulsifier component at 0.001% to 5%, by weight of said composition; h. and fiber component at 0.001% to 20%, by weight of said composition.

A further embodiment of the present invention is a composition comprising: a. liquid edible oil component at 12% to 20% (blend of canola, soybean oil and sunflower oil), by weight of said composition; b. 3% to 5% coconut oil component (0% to 16% virgin coconut oil and 84% to 100% refined coconut oil), by weight of said composition; c. condensed skim milk component at 20% to 30%, by weight of said composition; d. monosaccharide component at 15% to 20%, by weight of said composition; e. disaccharide component at 18% to 23%, by weight of said composition; f. vanilla powder component of 3%, by weight of said composition; g. an emulsifier component at 0.001% to 5%, by weight of said composition; h. fiber component at 0.001% to 20%, by weight of said composition; i. and a 1% or greater water component, by weight of said composition.

A further embodiment of the present invention is a composition comprising: a. liquid edible oil component at 12% to 20% (blend of canola, soybean oil and sunflower oil), by weight of said composition; b. 3% to 5% coconut oil component (0% to 16% virgin coconut oil and 84% to 100% refined coconut oil), by weight of said composition; c. condensed skim milk component at 20% to 30%, by weight of said composition; d. monosaccharide component at 15% to 20%, by weight of said composition; e. disaccharide component at 18% to 23%, by weight of said composition; f. vanilla powder component of 3%, by weight of said composition; g. an emulsifier component at 0.001% to 5%, by weight of said composition; h. fiber component at 0.001% to 20%, by weight of said composition; i. and a 1% or greater water component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component of a preservative component and mixing until the above mixture becomes homogeneous with the additional listed components.

Additionally, an embodiment of the present invention is a composition comprising the steps of: mixing ingredients comprising a liquid edible oil, coconut oil component, condensed skim milk component, monosaccharide component, disaccharide component, vanilla powder component, an emulsifier component, a fiber component, and a water component in a heating vessel; heating the ingredients to 150 to 160 degrees F. to dissolve the monosaccharide and disaccharide components and emulsify the liquid edible oil and coconut oil component to form a uniform heated mixture while scraping the vessel during heating to prevent scorching; and increasing the heat to 225 degrees F. to a slow boil for around 15 minutes so the ingredients get to a temperature and for a time long enough to achieve caramelization. The length of time that the composition would be boiled determines the viscosity of the final caramel flavored confection. In cases when a caramel flavored chew is the desired end result the length of time for boil would be longer vs. the time required for a more viscous end product that could be used for an ice cream topping or for an apple or fruit tray dip.

Once cooled to sufficient temperature, add to the above blended caramel flavored confection composition a preservative component of tocopherols at 0.001% of finished weight of composition, additional flavors, colors, or preservatives while blending with agitation.

In a second embodiment of the present invention a caramel flavored confection composition has improved taste, texture, melt, and creaminess versus fat free caramel flavored confections and has a balance of dietary fats plus beneficial essential fatty acids Omega 6 and Omega 3 ALA's, antioxidants, and dietary fiber compared to milk fat to or butter fat or both fat based caramel flavored confections or caramel or partially hydrogenated or fully hydrogenated based caramel flavored confections.

Such a composition comprises:
a. caramel confection component at 50% to 75% that consists of corn syrup, high fructose corn syrup, nonfat milk contains 2% or less of: corn starch-modified, natural flavors (from milk and soybean), salt
b. liquid edible oil component at 12% to 20% (blend of canola, soybean oil and sunflower oil)
c. 3% to 5% coconut oil component (0% to 16% virgin coconut oil and 84% to 100% refined coconut oil)
d. vanilla powder component of 3%
e. fiber component at 0.001% to 20%
f. emulsifier component at 0.001% to 5%
g. water component at 0% or greater

An embodiment of the present invention is a composition comprising: a. a caramel confection component at 75% that consists of corn syrup, high fructose corn syrup, nonfat milk contains 2% or less of: corn starch-modified, natural flavors (from milk and soybean), salt, by weight of said composition; b. liquid edible oil component at 12% to 20% (blend of canola, soybean oil and sunflower oil), by weight of said composition; c. 3% to 5% coconut oil component (0% to 16% virgin coconut oil and 84% to 100% refined coconut oil), by weight of said composition; d. vanilla powder component of 3%, by weight of said composition; e. fiber component at 0.001% to 20%, by weight of said composition; f. an emulsifier component at 0.001% to 5%, by weight of said composition; g. water component at 0% or greater, by weight of said composition; and a flavor component, a color component, a preservative component, a stabilizing component, a thickening component, or at least about 0% wt. % or greater of a supplement selected from the group consisting of: vitamins, minerals, herbs, botanicals, plant derived supplements, animal derived supplements, therapeutic compounds, and mixtures thereof; by weight of said composition.

Additionally, an embodiment of the present invention is a composition comprising the steps of: mixing a caramel confection component at 50% to 75% by weight of said composition that consists of corn syrup, high fructose corn syrup, nonfat milk contains 2% or less of: corn starch-modified, natural flavors (from milk and soybean), salt with the ingredients comprising a liquid edible oil, coconut oil component, vanilla powder component, an emulsifier component and a fiber component in a heating vessel; heating the ingredients to 165 degrees F. to dissolve the vanilla powder component and emulsify the liquid edible oil and coconut oil component to form a uniform heated mixture while scraping the vessel during heating to prevent scorching; and increasing the heat to a 225 degrees F. for 5 minutes to create the antioxidant flavor profile specific to our invention and in cases when a caramel flavored confection chew or hard candy is the desired end result the length of time for boil would be longer. The final caramel flavored confection can then be packaged in any manner suitable for caramel flavored confections known in the industry.

To improve the economics of the above caramel flavored confection manufacturing process all the above ingredients including the additional component of a flavor, a color, a preservative, a stabilizing agent, a thickening agent, a supplement, a nutraceutical, a. medicine or combinations thereof could be processed together. This would remove the necessity of the second blending and heating stage and would lower the cost of production.

Both of the above processes produce a caramel flavored confection that has improved taste, texture, melt, and creaminess versus fat free caramel flavored confections and has a balance of dietary fats plus beneficial essential fatty acids Omega 6 and Omega 3 ALA's, antioxidants, and dietary fiber compared to milk fat or butter fat or both based caramel and fat free caramel. These caramel flavored confections make a perfect base for caramel flavored milk. This caramel flavored milk would be processed in a number of ways understood by those skilled in the art of milk processing. Caramel flavored milk with improved health characteristics would be an important and beneficial addition to the flavored milk category, which is consumed by a wide group of consumers.

### DETAILED DESCRIPTION OF THE DRAWINGS

### Definitions

All percentages and ratios are calculated by weight unless otherwise indicated. All percentages and ratios are calculated based on the total final composition unless otherwise indicated.

Referenced herein may be trade names for components including various ingredients utilized in the present invention. The inventors herein do not intend to be limited by materials under a given trade name. Equivalent materials (e.g., those obtained from a different source under a different name or reference number) to those referenced by trade name may be substituted and utilized in the description.

As used herein “fiber” generally means material derived from plant cell walls and which is not digestible by human digestive enzymes, including soluble fiber and insoluble fiber. The fiber component can be naturally derived or synthetic. A portion of the fiber component can be non-starch polysaccharides, including soluble and non soluble fiber. As used herein “soluble fiber” means plant gums and oligosaccharides, or modified gums, modified celluloses, non-starch polysaccharides that are soluble in water, some of which can form viscous gels.

### THE INVENTION

Generally, as known in prior art many patents have been granted for caramel flavored confections and caramel products. Our current invention focused on improving the health characteristics of caramel flavored confections and expanding the potential consumer market for such confections by providing equivalent or superior taste, texture, creaminess, and melt vs current caramel flavored confections and caramel without the inclusion of ingredients such as milk fat or butter fat or both which exhibit negative health characteristics.

Many producers have created caramel flavored confections that are claimed to be “fat free”. (examples are several of Smucker's ice cream toppings). Consumers purchase such products for their purported heath benefits, without realizing that the “fat free” status of the formulation has been created by substituting sugar for fat and the consumer therefore trades one health improvement for a new health negative. Sugar is known to be one of the largest contributing factors to health problems and the many healthier alternative edible oils and fats now available can displace this sugar and give caramel flavored confections an improved health characteristic structure as created with our invention. Our invention displaces sugar with such alternative edible oils and fats and in certain embodiments can reduce sugar by over 50% while providing the consumer a healthy group of dietary fats and beneficial dietary fiber.

The uniqueness of the current invention is that we can improve the health characteristics of caramel flavored confections while improving the taste, texture, melt, and creaminess of the product and do so without the inclusion of milk fat, butter fat, or both in our formulations and we don't utilize any hydrogenated oils that add Trans fat to caramel flavored confections. The fact that our caramel flavored confection compositions are consumer proven to taste better than current caramel flavored confections used for ice cream toppings and fruit dips currently available in the market place, is a critical differentiating aspect of our invention and novel technology. Exhibit 1 clearly shows our superior consumer taste panel results for a caramel flavored confection created within claim 1 of our invention versus Smucker's toppings caramel flavored and Hershey's Caramel Flavored topping and T. Marzetti Apple and fruit dip caramel.

Another important aspect of this invention is that within certain embodiments we can create caramel flavored confection compositions that have nutritional contents that allow for the present invention to be widely recommended by the medical community as a healthy food choice. In certain combinations of our invention we can use certain ratios of ingredients to give the consumer beneficial dietary fiber and essential fats Omega 6 and Omega 3 that have proven health benefits compared to the milk fat or butter fat or both or partially hydrogenated or fully hydrogenated fats that are used in standard caramel flavored or caramel confections.

Through experimentation and extensive research and development it was discovered that an embodiment of the present invention comprises a composition having; a. liquid edible oil component at 12% to 20% (blend of canola, soybean oil and sunflower oil), by weight of said composition; b. 3% to 5% coconut oil component (0% to 16% virgin coconut oil and 84% to 100% refined coconut oil), by weight of said composition; c. condensed skim milk component at 15% to 20%, by weight of said composition; d. monosaccharide component at 15% to 20%, by weight of said composition; e. disaccharide component at 16% to 21%, by weight of said composition; f. vanilla powder component of 3%, by weight of said composition; g. an emulsifier component at 0.001% to 5%, by weight of said composition; h. fiber component at 0.001% to 20%, by weight of said composition; i. and a 5% or greater water component, by weight of said composition; at least about 0% wt. % or greater of a supplement selected from the group consisting of: vitamins, minerals, herbs, botanicals, plant derived supplements, animal derived supplements, therapeutic compounds, and mixtures thereof; by weight of said composition; and an additional component of a preservative component and mixing until the above mixture becomes homogeneous with the additional listed components.

### Liquid Edible Oil Component

The composition of the present invention includes an edible oil component at 12% to 20% of said invention. This edible oil component makes up part of the group of ingredients that adjust the taste, texture, and improve the melt and creaminess of the caramel flavored confection. The interaction of the group of highly unsaturated oils with the coconut oil component creates an improved elasticity within the caramel flavored confection that acts similar to regular milk fat or butter fat or both types of fat caramels. The edible oil component also improves the health characteristic of the caramel flavored confection compositions because it adds monounsaturated and polyunsaturated fats. An example of an edible oil component is a blend of canola, soybean oil, and sunflower oil. Non-limiting examples of an edible oil component acceptable for the present invention need to have low saturated fat content and high unsaturated fat including monounsaturated and especially polyunsaturated oils. The edible oil component needs to have no specific flavor and needs to be basically bland or somewhat buttery in taste. The edible oils component can come from the following; canola oil, soybean oil, safflower oil, sunflower oil, sesame oil, walnut oil, olive oil, flaxseed oil, chia seed oil, almond oil, corn oil, grape seed oil, peanut oil, other nut oils, and synthesized or reorganized oils, and combinations thereof. Use of certain oils within the present invention including walnut or chia seed oil especially would move the final non-standardized high cocoa dark chocolate composition towards the most balanced structure possible between saturated, monounsaturated, and polyunsaturated fats and would include excellent amounts of Omega 3 ALA's and Omega 6 essential fatty acids within the compositions.

Coconut Oil Component (0% to 16% virgin coconut oil and 84% to 100% refined coconut oil)

The composition of the present invention comprises 3% to 5% of a virgin coconut oil component. This virgin coconut oil component at 0% to 16% virgin coconut oil and 84% to 100% refined coconut oil is a critical part of the flavor profile unique to our caramel flavored confection and it improves the taste, texture, melt, and creaminess of the compositions. The blend of the flavor components is a critical aspect of how the present invention accomplishes the improved taste, texture, melt and creaminess compared to fat free caramel flavored confections and how it has similar taste, texture, melt and creaminess compared to milk fat, butter fat or both, partially hydrogenated or fully hydrogenated fat caramel flavored confections or caramel. Therefore, it is necessary for the caramel flavored confection that utilizes virgin coconut oil component in the composition to have a good flavor profile and not to have any of the flavor profile removed by processing the oil. Nature's Flavors supplies a kosher virgin coconut oil that has good flavor and works well within the present invention. Any medium heat processed coconut oil can be used for the rest of the coconut oil component.

### Condensed Skim Milk Component

The composition of the present invention comprises 15% to 20% a condensed skim milk component. This condensed skim milk component is part of the ingredients that help create the caramelization process and end flavor blend that makes up our caramel flavored confection. This ingredient can be supplied by any food service company and needs to be only made to specifications for the standard of identity for condensed skim milk. Skim milk or powdered skim milk could also be used, but the water content in the composition would have to be adjusted.

### Monosaccharide Component

The composition of the present invention comprises 15% to 20% a monosaccharide component. Corn syrup is the preferred monosaccharide used in the present invention. Other examples of monosaccharides that could be used are glucose (dextrose), fructose (levulose), galactose, xylose and ribose. Corn syrup in the present invention interacts with the disaccharide components and the milk protein to create the Maillard, Caramelization or both reactions.

### Disaccharide Component

The composition of the present invention comprises 16% to 21% a disaccharide component. Sucrose is the preferred disaccharide used in the present invention. The sugar from the condensed skim milk provides some additional disaccharide component in the form of lactose a combination of glucose and galactose.

### Vanilla Powder Component

The composition of the present invention includes a 3% vanilla powder component. This vanilla powder component comes from a vanilla extract sprayed on a dextrose base. This vanilla powder component makes up part of the flavor profile that along with the virgin coconut oil and caramelization of the milk protein and sugars has a synergistic effect on improving the taste, texture, melt, and creaminess of or caramel flavored confection compositions. The blend of flavor components is a critical aspect of how the present invention accomplishes the improved taste, texture, melt and creaminess without the necessity for milk fat, butter fat, partially hydrogenated or fully hydrogenated fats. Our invention has the same rich and creamy taste and texture without the negative health ramifications of animal saturated fat or Trans fat. Therefore, it is necessary for the vanilla powder component to have a specific flavor profile and Cook's Flavoring Company currently sells the vanilla powder that is within the flavor component of the present invention. Another vanilla powder or natural vanilla extract could be used, but it would have to have a similar taste profile and must be have the same structure as the Cook's Flavoring Company's vanilla powder.

### Emulsifier Component

The composition of the present invention includes a 0.001% to 5% emulsifier component. This emulsifier component can come from several different ingredients. The present invention uses lecithin as the emulsifier agent. The emulsifier agent acts as an agent to keep the mixture of two or more liquids in which one is dispersed in the other as microscopic or ultramicroscopic droplets. In the caramel flavored confection of the present invention this is the water and oil emulsion that creates the smooth texture of the finished product.

### Fiber Component

The composition of the present invention includes a 0.001% to 20% fiber component. The chosen fiber component for the present invention is Inulin. Inulin acts as a thickening agent and also improves the texture of the caramel flavored confection. Various load rates of Inulin can be incorporated in the invention to create improved texture and at certain load rates can provide dietary benefits including promoting a healthy digestion system, controlling blood sugar levels, and providing probiotic benefits.

Additionally, embodiments of the caramel flavored confection compositions can include at least about 0% or greater, by weight of the composition, a supplement component such as, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

Alternatively, the composition of the present invention can include from about 0% to about 25%, alternatively from about 0% to about 10%, and alternatively from about 0% to about 5%, by weight of the composition, of a supplement component.

### Preservative Components

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the present invention can include at least about 0% to 2%, by weight of the composition a preservative component from above or mixtures thereof.

### Method of Making

The present invention is a composition comprising the steps of: mixing ingredients comprising a liquid edible oil, coconut oil component, condensed skim milk component, monosaccharide component, disaccharide component, vanilla powder component, an emulsifier component, a fiber component, and a water component in a heating vessel; heating the ingredients to 150 to 160 degrees Farenheit for 5 to 10 minutes to dissolve the monosaccharide and disaccharide components and emulsify the liquid edible oil and coconut oil component to form a uniform heated mixture while scraping the vessel during heating to prevent scorching; and increasing the heat to 225 degrees Fahrenheit at a rolling boil to bring the ingredients to a temperature and for a time to achieve caramelization. The length of time that the composition boils determines the thickness of the final caramel flavored confection. For an ice cream topping or fruit dip type of caramel flavored confection the time would usually be around 15 at a slow boil to create the correct viscosity and in cases when a caramel flavored chew or hard candy is the desired end result the length of time for boil would be longer.

Another method suitable for manufacture of the present invention would comprise the steps including; mixing the ingredients comprising a liquid edible oil, coconut oil component, condensed skim milk component, monosaccharide component, disaccharide component, vanilla powder component, an emulsifier component, a fiber component, and a water component would be homogenized, then cooked at 225 degrees Fahrenheit with agitation to create the caramelization process.

is Once cooled to sufficient temperature around 93 degrees Fahrenheit add to the above blended caramel flavored confection composition a preservative component of tocopherols and a color component while blending with agitation. The caramel flavored confection would then be processed via a confectionery extrusion or caramel processing line into bite size chews, bite size hard candies or squares or other shapes, other molded shapes, or other types of packaging like tubs, jars, etc. These bite sized chews or hard candies pieces or squares would be either flow wrap packaged or wrapper packaged based on the type of product being created. These wrapped confectionery products would then be packaged in secondary packaging including but not limited to bags or cartons, pop boxes, sleeves, or cardboard cases. The finished caramel flavored confection could also be used as a filling for a confectionery or food, an enrobing material for confectionery or food, a layering material for a confectionery or food, or an ingredient for a confectionery or food.

### EXAMPLES

The below examples are included for illustrative purposes only and are not intended to in any way limit the scope of the present invention.

### Example 1

A caramel flavored confection with improved health characteristics, less sugar, balance of dietary fats, and beneficial antioxidants and dietary fiber suitable for an ice cream topping

Add 15# of Crisco Vegetable Oil Blend (Canola, Soybean, and Sunflower), add 3# of coconut oil (90% refined coconut oil and 10% Nature's Flavors virgin coconut oil), add 20# of condensed skim milk, add 15# of corn syrup, add 18# of sucrose, add 3# of vanilla powder supplied by Cooks Flavor Company, add 1# of lecithin, add 5# of Inulin, and 5# water, and 1# salt. Mix together all ingredients into a kettle equipped with a gas heater and mixer. Mix together and warm to 150 to 160 degree F. over a low flame. Constantly scrape the side of the kettle to prevent scorching. Continue mixing and scraping for 10 minutes to dissolve the sugar and emulsify the fat, maintain the temperature at 150 to 160 degree F. Increase the heat gas flame and boil slowly to 225 degree Fahrenheit. The batch should be boiled for about 10 to 15 minutes to develop sufficient caramelization (continue mixing and scraping). The batch would then be tested for thickness and would either be taken of the flame and cooled or continue to boil for some additional time to create the required viscosity for the caramel flavored confection being chosen to make. It would be cooled and tocopherols at 0.001% of the batch would be blended into the mixture for a natural preservative and a color could be added if desired. This type of process could be extrapolated into large scale production with possible a homogenization and either jar and cap or squeezable type of packaging known in the ice cream toppings industry.

### Example 2

A caramel flavored confection chew with improved health characteristics, balance of dietary fats, beneficial antioxidants and dietary fiber plus plant sterols and Omega 3 EPA/DHA supplements

Add 15# of Crisco Vegetable Oil Blend (Canola, Soybean, and Sunflower), add 3# of coconut oil (100% medium heat refined coconut oil), add 20# of condensed skim milk, add 15# of corn syrup, add 18# of sucrose, add 3# of vanilla powder supplied by Cooks Flavor Company, add 1# of lecithin, add 15# of Inulin, and 2# water, and 1# salt. Mix together all ingredients into a kettle equipped with a gas heater and mixer. Mix together and warm to 150 to 160 degree F. over a low flame. Constantly scrape the side of the kettle to prevent scorching. Continue mixing and scraping for 10 minutes to dissolve the sugar and emulsify the fat, maintain the temperature at 150 to 160 degree F. Increase the heat gas flame and boil slowly to 235 degree F. The batch should be boiled for about 10 to 15 minutes to develop sufficient caramelization (continue mixing and scraping). The batch would then be tested for thickness and would either be taken of the flame and cooled or continue to boil for some additional time to create the required viscosity for the caramel flavored confection chew. Once cooled to around 93 degrees Fahrenheit the plant sterols would be blended into the mixture at 0.8 grams per serving and a stabilized Omega 3 DHA/EPA would be blended in at 260 mg per serving to the above blended caramel flavored confection composition. Then a preservative component of tocopherols added at 0.001% of the composition and a color component would be added while blending with agitation. The serving size would be around 14 grams per chew. A hard candy caramel flavored confection could be produced by reducing the thickness down at the boil stage to a viscosity that creates a hard candy at room temperature. This batch would then be cooled to 93 degrees Fahrenheit and the plant sterols would be blended into the mixture at 0.8 grams per serving and a stabilized Omega 3 DHA/EPA would be blended in at 260 mg per serving to the blend. The serving size would also be around 14 grams per hard candy.

Through experimentation and extensive research and development it was discovered that an embodiment of the present invention comprises a composition having; a caramel confection component at 75% that consists of corn syrup, high fructose corn syrup, nonfat milk contains 2% or less of: corn starch-modified, natural flavors (from milk and soybean), salt, by weight of said composition; b. a liquid edible oil component at 12% to 20% (blend of canola, soybean oil and sunflower oil), by weight of said composition; c. a 3% to 5% coconut oil component (0% to 16% virgin coconut oil and 84% to 100% refined coconut oil), by weight of said composition; d. a vanilla powder component of 3%, by weight of said composition; e. a fiber component at 0.001% to 20%, by weight of said composition; f. an emulsifier component at 0.001% to 5%, by weight of said composition; g. a water component at 0% or greater, by weight of said composition; and a flavor component, a color component, a preservative component, a stabilizing component, a thickening component, or a supplement component or combinations thereof.

### Caramel Confection Component

The composition of the present invention comprises a 75% component of a caramel flavored confection. This caramel flavored confection can come from many different sources. In one embodiment of this invention a caramel flavored confection consists of corn syrup, high fructose corn syrup, nonfat milk, corn starch-modified, natural flavors (from milk and soybean), salt. This caramel flavored confection must be fat free because the present invention adds a healthy group of dietary fats as part of the composition.

### Liquid Edible Oil Component

The composition of the present invention includes an edible oil component at 12% to 20% of said invention. This edible oil component makes up part of the group of ingredients that adjust the taste, texture, and improve the melt and creaminess of the caramel flavored confection. The edible oil with high levels of unsaturated fat interacts with the coconut oil component within the composition and this creates a unique new improved elasticity within the caramel flavored confection. The edible oil component also improves the health characteristic of the caramel flavored confection compositions because it adds monounsaturated and polyunsaturated fats. An example of an edible oil component is a blend of canola, soybean oil, and sunflower oil. Non-limiting examples of an edible oil component acceptable for the present invention need to have low saturated fat content and high unsaturated fat including monounsaturated and especially polyunsaturated oils. The edible oil component needs to have no specific flavor and needs to be basically bland or somewhat buttery in taste. The edible oils component can come from the following; canola oil, soybean oil, safflower oil, sunflower oil, sesame oil, walnut oil, olive oil, flaxseed oil, chia seed oil, almond oil, corn oil, grape seed oil, peanut oil, other nut oils, and synthesized or reorganized oils, and combinations thereof. Use of certain oils within the present invention including walnut or chia seed oil especially would move the final non-standardized high cocoa dark chocolate composition towards the most balanced structure possible between saturated, monounsaturated, and polyunsaturated fats and would include excellent amounts of Omega 3 ALA's and Omega 6 essential fatty acids within the compositions.

Coconut Oil Component (0% to 16% virgin coconut oil and 84% to 100% refined coconut oil)

The composition of the present invention comprises 3% to 5% of a coconut oil component (0% to 16% virgin coconut oil and 84% to 100% refined coconut oil). The flavor of the coconut oil is a critical part of the flavor profile unique to our caramel flavored confection and it improves the taste, texture, melt, and creaminess of the compositions. The blend of the flavor components is a critical aspect of how the present invention accomplishes the improved taste, texture, melt and creaminess compared to fat free caramel flavored confections and how it has similar taste, texture, melt and creaminess compared to milk fat, butter fat or both, partially hydrogenated or fully hydrogenated fat caramel flavored confections or caramel. Therefore, it is necessary for the virgin coconut oil component to have a good flavor profile and not to have any of the flavor profile removed by processing the oil. Nature's Flavors supplies a kosher virgin coconut oil that has good flavor and works well within the present invention. Any medium heat processed coconut oil can be used for the rest of the coconut oil component.

### Vanilla Powder Component

The composition of the present invention includes a 3% vanilla powder component. This vanilla powder component comes from a vanilla extract sprayed on a dextrose base. This vanilla powder component makes up part of the flavor profile that along with the virgin coconut oil and caramelization of the milk protein and sugars has a synergistic effect on improving the taste, texture, melt, and creaminess of or caramel flavored confection compositions. The blend of flavor components is a critical aspect of how the present invention accomplishes the improved taste, texture, melt and creaminess without the necessity for milk fat, butter fat, partially hydrogenated or fully hydrogenated fats. Our invention has the same rich and creamy taste and texture without the negative health ramifications of animal saturated fat or Trans fat. Therefore, it is necessary for the vanilla powder component to have a specific flavor profile and Cook's Flavoring Company currently sells the vanilla powder that is within the flavor component of the present invention. Another vanilla powder or natural vanilla extract could be used, but it would have to have a similar taste profile and must be have the same structure as the Cook's Flavoring Company's vanilla powder.

### Fiber Component

The composition of the present invention includes a 0.001% to 20% fiber component. The chosen fiber component for the present invention is Inulin. Inulin acts as a thickening agent and also improves the texture of the caramel flavored confection. Various load rates of Inulin can be incorporated in the invention to create improved texture and at certain load rates can provide dietary benefits including promoting a healthy digestion system, controlling blood sugar levels, and providing probiotic benefits.

Additionally, embodiments of the caramel flavored confection compositions can include at least about 0% or greater, by weight of the composition, a supplement component such as, but not limited to, vitamins, minerals, herbs, botanicals, plant derived supplements, animal derived supplements, therapeutic compounds, and mixtures thereof.

Non-limiting examples of such other components include: calcium, potassium, B vitamins, vitamins A, C, D, E, and K, folic acid, other vitamins and minerals commonly known in the art and used for supplementing the diet; extracts and active phytochemicals including ferulic acid (from apples), ginseng, ginko biloba, beta carotene, capsicanoids, anthocyanidins, bioflavinoids, d-limonene, isothiocyanates, cysteines from garlic, ginger, grapes, catechins and polyphenols from teas, onions, phytosterols, isoflavones, lycopene, curcumin, caffeine; glucosamine, chondroitin, msm; melatonin, seratonin; and mixtures thereof.

Alternatively, the composition of the present invention can include from about 0% to about 25%, alternatively from about 0% to about 10%, and alternatively from about 0% to about 5%, by weight of the composition, of a supplement component.

### Preservative Components

Non-limiting examples of suitable preservatives include: sodium benzoate, sodium citrate, sodium phosphate, potassium metabisulfite, sodium metabisulfite, sodium lactate, sodium sulfite, EDTA (ethylenediaminetetraacetic acid), methylparaben, TBHQ, tocopherols, and mixtures thereof.

The compositions of the present invention can include at least about 0% to 2%, by weight of the composition a preservative component from above or mixtures thereof.

### Method of Making

Mixing a caramel confection component at 75% by weight of said composition that consists of corn syrup, high fructose corn syrup, nonfat milk contains 2% or less of: corn starch-modified, natural flavors (from milk and soybean), salt with the ingredients comprising a liquid edible oil, coconut oil component, vanilla powder component, an emulsifier component and a fiber component in a heating vessel, and a water component; heating the ingredients to 160 to 165 degrees Fahrenheit to dissolve the vanilla powder component and emulsify the liquid edible oil and coconut oil component to form a uniform heated mixture while scraping the vessel during heating to, prevent scorching; and increasing the heat to a 225 degrees Fahrenheit for 5 minutes to create the antioxidant flavor profile or bring to a boil under agitation and stirring for a thicker final caramel flavored confection and in cases when a caramel flavored confection chew or hard candy is the desired end result the length of time for boil would be longer. Once cooled to sufficient temperature, add to the above blended caramel flavored confection composition a preservative component of tocopherols at 0.001% of the composition and a color component while blending with agitation. Additional preservatives or colors can be added.

The caramel flavored confection would then be processed via a confectionery extrusion or caramel processing line into bite size chews, bite sized hard candies, bite size squares, other molded shapes, or other types of packaging like tubs, jars, etc. These bite sized chews or hard candies would be either flow wrap packaged or wrapper packaged based on the type of product being created. These wrapped confectionery products would then be packaged in secondary packaging including but not limited to bags or cartons, pop boxes, sleeves, or cardboard cases. Or use the composition for a filling for a confectionery or food, an enrobing material for confectionery or food, a layering material for a confectionery or food, or an ingredient for a confectionery or food.

To improve the economics of the above caramel flavored confection manufacturing process all the above ingredients including the additional component of a flavor, a color, a preservative, a stabilizing agent, a thickening agent, a supplement or combinations thereof could be processed together. This would remove the necessity of the second blending and heating stage and would lower the cost of production.

### EXAMPLES

The below examples are included for illustrative purposes only and are not intended to in any way limit the scope of the present invention.

### Example 1

Caramel flavored confection with improved health characteristics, antioxidant content, lower sugar content, balance of dietary fats, and beneficial fiber suitable for an ice cream topping

Add 75# of caramel flavored confection consisting of corn syrup, high fructose corn syrup, nonfat milk contains 2% or less of: corn starch-modified, natural flavors (from milk and soybean), salt, Add 15# of Crisco Vegetable Oil Blend (Canola, Soybean, and Sunflower), add 3# of coconut oil (90% medium heat refined coconut and 10% virgin coconut), add 3# of vanilla powder supplied by Cooks Flavor Company, add 1# of Inulin, add 4# of water. Mix together all ingredients into a kettle equipped with a gas heater and mixer. Mix together and warm to 150 to 160 degree F. over a low flame. Constantly scrape the side of the kettle to prevent scorching. Continue mixing and scraping for 10 minutes to dissolve the vanilla powder on the dextrose base and emulsify the fat, maintain the temperature at 150 to 160 degree F. Increase the heat gas flame and cook at 225 degree F. for 5 minutes create the antioxidant flavor profile that comes from the caremelization of the coconut oil, vanilla powder, sugars, and milk protein to create the unique flavor profile of our caramel flavored confection. The batch would then be tested for thickness and would either be taken of the flame and cooled or sufficient water would be added to the formula and continue to boil for some additional time to create the required viscosity for the caramel flavored confection. Once cooled to sufficient temperature, add to the above blended caramel flavored confection composition a preservative component of tocopherols and a color component while blending with agitation. Additional preservatives or colors can be added.

### Example 2

Caramel flavored confection with improved health characteristics, antioxidant content, lower sugar content, balance of dietary fats, and beneficial fiber suitable for apple or fruit dip

Add 75# of caramel flavored confection consisting of corn syrup, high fructose corn syrup, nonfat milk contains 2% or less of: corn starch-modified, natural flavors (from milk and soybean), salt, Add 15# of Crisco Vegetable Oil Blend (Canola, Soybean, and Sunflower), add 3# of coconut oil (90% refined medium heat coconut oil and 10% virgin coconut oil), add 3# of vanilla powder supplied by Cooks Flavor Company, add 10# of Inulin, add 4# of water. Mix together all ingredients into a kettle equipped with a gas heater and mixer. Mix together and warm to 150 to 160 degree F. over a low flame. Constantly scrape the side of the kettle to prevent scorching. Continue mixing and scraping for 10 minutes to dissolve the vanilla powder on the dextrose base and emulsify the fat, maintain the temperature at 150 to 160 degree F. Increase the heat gas flame and cook at 225 degree F. for 15 minutes to create the antioxidant flavor profile that comes from the caramelization of the coconut oil, vanilla powder, sugars, and milk protein to create the unique flavor profile of our caramel flavored confection. The batch would then be tested for thickness and would either be taken of the flame and cooled or continue to boil for some additional time to create the required viscosity for the caramel flavored confection. Once cooled to sufficient temperature, add to the above blended caramel flavored confection composition a preservative component of tocopherols at 0.001% of the composition and a color component while blending with agitation. Additional preservatives or colors can be added.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Exhibit 1

CARAMEL FLAVORED CONFECTION
COMPOSITION VS. COMPETITOR'S SENSORY
RESULTS (10 CONSUMERS TASTED EACH)*

| | Caramel Flavored | | |
|---|---|---|---|
| | Confection Topping | Hershey | Smucker's |
| | 25% Less Sugar**, | Caramel Flavored | toppings |
| | Balance Fats, Fiber | topping | Caramel Flavored |
| Taste*** | 9**** | 7 | 8 |
| Texture | 9 | 7 | 7 |
| Melt | 9 | 6 | 7 |
| Creaminess | 9 | 6 | 8 |
| Mouthfeel | 9 | 7 | 7 |
| Finish | 9 | 7 | 7 |
| Aftertaste | 9 | 6 | 7 |
| Experience | 9 | 7 | 7 |
| Overall | 9 | 6 | 7 |

*Consumers chosen were ice cream topping eaters.
**25% Less sugar versus industry average of 52% plus.
***Each sensory characteristic was rated on a scale of 1 to 9, 1 being poor and 9 being excellent.
****Each score was tabulated by taking the total number of consumers polled being 10 for each sample and adding up the total score for each sensory characteristic and then dividing by 10. This gives the average rating per 10 consumers on each sensory characteristic polled for each of the above six samples of non-standardized milk chocolate compositions created from our invention.

The samples were given to the consumers randomly so not to give any sample an advantage. The survey was done at a local convenience store that sells both brands of competitive products.

What is claimed is:

1. An improved health characteristic, antioxidant content, reduced sugar content and dietary benefit caramel flavored confection, chew, hard candy comprising; a. a liquid edible oil component at 4% to 30%, by weight of said composition; b. a coconut oil component (0% to 16% virgin coconut oil and 84% to 100% refined coconut oil) at 1% to 8%, by weight of said composition; c. a milk solids component at 10% to 30%, by weight of said composition; a monosaccharide component at 10% to 30%, by weight of said composition; d. a disaccharide component at 10% to 30%, by weight of said composition; e. a vanilla powder component of 1% to 5%, by weight of said composition; f. an emulsifier component at 0.001% to 5%, by weight of said composition; g. a fiber component at 0.001% to 20%, by weight of said composition; h. a water component at 1% or greater, by weight of said composition.

2. An improved health characteristic, antioxidant content, reduced sugar content and dietary benefit caramel flavored confection, chew, hard candy comprising a. a caramel flavored confection similar to Smucker's toppings caramel flavored or Hershey's Syrup Caramel that contains a range of ingredients like corn syrup, high fructose corn syrup, nonfat milk or sweetened condensed milk, colors, preservatives, emulsifiers, thickening agents, flavors, and 0% to greater additional water component at 55% to 80%, by weight of said composition b. a liquid edible oil component at 4% to 30%, by weight of said composition; c. a coconut oil component (0% to 16% virgin coconut oil and 84% to 100% refined coconut oil) at 1% to 8%, by weight of said composition; d. a vanilla powder component of 1% to 5%, by weight of said composition; e. an emulsifier component at 0.001% to 5%, by weight of said composition; f. a fiber component at 1% to 20%, by weight of said composition; g. 0% to greater a water component, by weight of said composition.

3. The composition of claim 1 and claim 2 wherein an edible oil component is 4% to 30%, 4% to 10%, alternatively 10% to 15%, alternatively 15% to 20%, alternatively 20% to 25%, alternatively 25% to 30% with a high level of unsaturated fatty acids, by weight of said composition.

4. The composition of claim 3 where the edible oil component is comprised of the group of edible oils including; canola oil, soybean oil, safflower oil, sunflower oil, sesame oil, walnut oil, olive oil, flaxseed oil, chia seed oil, almond oil, corn oil, grape seed oil, peanut oil, other nut oils, and combinations thereof or other edible oils or synthesized or rearranged oils with similar characteristics that have a high level of unsaturated fatty acids.

5. The composition of claim 4 wherein the preferred edible oil is a blend of canola, soybean oil, and sunflower oil or a blend of canola, soybean oil, and olive oil.

6. The composition of claim 1 and claim 2 wherein a coconut oil component (0% to 16% virgin coconut oil and 84% to 100% refined coconut oil) is at 1% to 8%, alternatively 1% to 3% and ideally 3% to 5%, and ultimately 5% to 8%, by weight of said composition. The virgin coconut oil adds a specific flavor and antioxidants to the caramel flavored confection and creates a unique flavor blend with the vanilla powder component and caramel flavor to create a unique flavor profile specific to this invention.

7. The composition of claim 1 wherein a milk solids component is 10% to 30%, by weight of said composition.

8. The composition of claim 1 wherein a milk solids component consists of the following; condensed skim milk, sweetened condensed skim milk, condensed whole milk, sweetened condensed whole milk, whole milk powder, non-fat milk powder, whey protein, whey protein concentrate, and the like, whole milk, skimmed milk, partially defatted milk and fortified milk. The milk solids can be adjusted to give the product classic milk fat caramel flavor and texture, but our invention can create this top quality classic milk fat caramel flavor and texture with a non-fat milk component; thus improving the health characteristics of the caramel flavored confection.

9. The composition of claim 8 wherein condensed skim milk, skim milk or skim milk powder is the milk solids component.

10. The composition of claim 1 wherein a monosaccharide and a disaccharide component are 10% to 30%, alternatively 10% to 15% and preferably 15% to 20%, alternatively 20% to 25%, alternatively 25% to 30%, by weight of said composition.

11. The composition of claim 10, wherein corn syrup and fructose comprise the monosaccharides and sucrose comprises the disaccharide.

12. The composition of claim 10, wherein corn syrup is the preferred monosaccharide and sucrose is the preferred disaccharide.

13. The composition of claim 1 and claim 2 wherein a vanilla powder component is 1% to 5%, by weight of said composition.

14. The composition of claim 13 wherein the vanilla powder is a form of natural vanilla extract sprayed on a dextrose base. This vanilla powder is part of an antioxidant flavor profile that combines with the virgin coconut oil and the caramelization flavor to create a unique caramel flavored confection taste profile superior to regular fat free caramel flavored confections and similar to superior to high milk fat based caramel.

15. The composition of claim 1 and claim 2 wherein an emulsifier component is 0.001% to 5%, by weight of said compositions.

16. The composition of claim 15 wherein an emulsifier component consists of one the following; lecithin, mono- and diglycerides, modified corn starch, or other suitable emulsifiers known to be used in caramel or confectionery production.

17. The composition of 16 wherein the emulsifier is modified corn starch or lecithin.

18. The composition of claim 1 and claim 2 wherein a fiber component is 0.001% to 20%, alternatively 0.001 to 5%, alternatively 5% to 10%, alternatively 10% to 15%, alternatively 15% to 20%.

19. The composition of claim 18 wherein a fiber component consists of one of the following; naturally derived soluble fiber, naturally derived inulin, inulin extract, synthetic inulin, hydrolysis products of inulin commonly known as fructooligosaccharides,
galacto-oligosaccharides, xylooligosaccharides, oligo derivatives of starch; husks; brans; psyllium; polysaccharides, starches; polycarbophil; lignin; arabinogalactans; chitosans; oat fiber; soluble corn fiber, non-digestible corn dextrin; non-digestible wheat dextrin; locust bean gum and derivatives of locust bean gum; hydroxypropylmethyl cellulose (HPMC); pectin; and mixtures thereof.

20. The composition of claim 19 wherein the fiber component is naturally derived inulin or psyllium or both.

21. The composition of claim 1 wherein a water component is 1% or greater, by weight of component and the composition of claim 2 wherein a water component is 0% or greater, by weight of said composition. Water component would be higher if utilizing dry or evaporated milk in the caramel flavored confection or if trying to produce an ice cream or fruit dip type of product.

22. The composition of claim 1 and claim 2 that comprises at least 0% or greater a supplement component consisting of the following; vitamins, minerals, herbs, botanicals, essential fatty acids, seeds, plant derived supplements including sterols and stanols, animal derived supplements, therapeutic compounds, and mixtures thereof; by weight of said composition.

23. The composition of claim 22 wherein a supplement component consists of Omega 3 DHA/EPA and plant sterols. The caramel flavored confection that contains Omega 3 DHA/EPA and plant sterols can be either in the form of a caramel confection chew or could be in a tub format. This caramel flavored confection would contain 200 mg or above Omega 3 DHA/EPA and 0.8 grams or greater plant sterols per serving and would have the ability to remove bad cholesterol out of the blood stream, lower total cholesterol, and improve the ratio of good HDL cholesterol to bad LDL cholesterol. The science behind Omega 3 DHA/EPA and plant sterols and cholesterol control is well understood and scientifically proven in the medical sciences.

24. The composition of claim 1 and claim 2 further comprising the step of adding an additional component selected from the group consisting of; a flavor component, a color component, a preservative component, a stabilizing component, and a thickening component.

25. The composition of claim 1 more specifically would comprise the following:
a. liquid edible oil component at 12% to 20% (blend of canola, soybean oil and sunflower oil)
b. 3% to 5% coconut oil component (0% to 16% virgin coconut oil and 84% to 100% refined coconut oil)
c. condensed skim milk component at 20% to 30%
d. monosaccharide component at 15% to 20%
e. disaccharide component at 18% to 23%
f. vanilla powder component of 3%
g. emulsifier component at 0.001% to 5%
h. fiber component at 0.001% to 20%
i. 1% or greater water component

26. The composition of claim 2 more specifically would comprise the following:
a. caramel confection component at 50% to 75% that consists of corn syrup, high fructose corn syrup, nonfat milk and contains 2% or less of: corn starch-modified, natural flavors (from milk and soybean), salt
b. liquid edible oil component at 12% to 20% (blend of canola, soybean oil and sunflower oil)
c. 3% to 5% coconut oil component (0% to 16% virgin coconut oil and 84% to 100% refined coconut oil)
d. vanilla powder component of 3%
e. fiber component at 0.001% to 20%
f. emulsifier component at 0.001% to 5%
g. 0% to greater a water component

27. The composition of claim 25 and claim 26 wherein a supplement component is added to the composition.

28. The composition of claim 27 wherein the supplement component is 0% or greater Omega 3 DHA/EPA and 0% or greater a plant sterols component, by weight of said composition. The caramel flavored confection that contains Omega 3 DHA/EPA and plant sterols can be either in the form of a caramel confection chew or could be in a viscous form contained in a tub, squeeze bottle or tube type package. This caramel flavored confection would contain 200 mg or above Omega 3 DHA/EPA and 0.8 grams or greater plant sterols per serving and would have the ability to remove bad cholesterol out of the blood stream, lower total cholesterol, and improve the ratio of good HDL cholesterol to bad LDL cholesterol. The science behind Omega 3 DHA/EPA and plant sterols and cholesterol control is well understood and scientifically known in the medical sciences.

29. The composition of claim 1 and claim 2 wherein said composition comprises a form selected from the group consisting of: bite size pieces, chews, hard caramel flavored confection pieces in any shapes or squares or rectangles of specific weight, varying molded shapes or sizes that are available for caramel flavored confection products including a layer for a confectionery or food, filling for a confectionery or food, an ingredient for a confectionery or food, tubs or containers including squeezable containers such as used for apple dippers or fruit dips, plastic or glass jars for ice cream toppings or dips, larger containers suitable for food service and individual single serving convenience containers used at fast food outlets.

30. A method of preparing a composition of claim 25 that creates an improved health characteristic, antioxidant content, lower sugar content and dietary benefit caramel flavored confection by mixing ingredients comprising a liquid edible oil, coconut oil component, condensed skim milk component, monosaccharide component, disaccharide component, vanilla powder component, an emulsifier component, a fiber component, and a water component in a heating vessel; heating the ingredients to form 150 degrees F. to 160 degrees F. to dissolve the sugars and emulsify the fats into a uniform heated mixture while scraping the vessel during heating to prevent scorching; and increasing the heat to boil the ingredients to a temperature of 225 degrees F. for 10 to 15 minutes and for a time to achieve caramelization and to produce our specific antioxidant flavor profile that comes from the coconut oil and the vanilla powder flavors blending with the caramelization flavor. The complete group of ingredients could be homogenized prior to heating as an additional microbial prevention step and then cooked at 225 degrees F. with agitation. The method of preparing the caramel flavored confection could also be mechanized into a caramel cooking system or complete caramel producing production plant as supplied by BCH Caramel Systems.

31. A method of preparing a composition of claim 26 that creates an improved health characteristic, antioxidant content, lower sugar content and dietary benefit caramel flavored confection by mixing ingredients comprising of an already made caramel flavored confection component that consists of corn syrup, high fructose corn syrup, nonfat milk and contains 2% or less of: corn starch-modified, natural flavors (from milk and soybean), salt, adding a liquid edible oil, adding a coconut oil component, adding a vanilla powder component, and adding a fiber component, and adding a water component if necessary and heating the ingredients to 165 degrees F. to dissolve the sugars in the vanilla powder and to emulsify the fats into a uniform heated mixture while scraping the vessel during heating to prevent scorching. The mixture would then be increased to 225 degrees F. for 5 minutes to create the specific antioxidant flavor profile that comes from the interaction of the coconut oil, the vanilla powder, and the caramelization flavor combination. Water may need to be added at the cooking stage to produce the right viscosity for the finished product. This method of preparing could also be mechanized into a complete caramel producing production plant as supplied by BCH Caramel Systems. Our novel group of ingredients and method of processing that creates our specific antioxidant flavor profile caramel flavored confection could be combined with the above already made caramel flavored confection ingredients in the original processing of the above caramel flavored confection to eliminate the double processing requirements. Economics of production costs and sensory characteristics of the final caramel flavored confection would determine the ultimate production technique chosen.

32. The method of claim 30 and claim 31 wherein an additional component or components would be added to the caramel flavored confection selected from the group consisting of; a flavor component, a color component, a preservative component, a stabilizing component, an emulsifier component, a thickening component, a supplement component, a nutraceutical component, a medicine component or combinations thereof.

33. The method of claim 30 and claim 31 further comprising the step of processing said final mixture via a confectionery line into bite size chews, bite size hard candy pieces or squares, other molded shapes, or other types of packaging such as tubs, jars, etc. These bite sized chews or hard caramel flavored confection pieces, shapes, or squares would be either flow wrap packaged or wrapper packaged based on the type of product being created. These wrapped confectionery products would then be packaged in secondary packaging including but not limited to bags or cartons, pop boxes, sleeves, or cardboard cases. Or using the composition for a filling for a confectionery or food, an enrobing material for confectionery or food, a layering material for a confectionery or food, or an ingredient for a confectionery or food.

34. The method of claim 30 and claim 31 wherein the caramel confections are suitable to be used as a base in the manufacture of caramel milk that would have improved health characteristics, a better balance of dietary fats, a dietary fiber component, and potentially a supplement component. The caramel confection base would be added to the correct amount of milk created by hydrating with water an evaporated milk or using an already produced milk. The fat content can be varied by the amount of milk fat within the milk component and the caramel confection base. The combined caramel confection and milk component would then be sterilized in a method known to those skilled in milk processing.

35. The method of claim 34 wherein the final caramel milk is packaged in any number of existing milk containers including; cans, plastic bottles, cartons, shelf stable containers, plastic containers, or other packaging utilized in the milk industry.
